(19) United States
(12) Patent Application Publication
(10) Pub. No.: US 2026/0045757 A1
(43) Pub. Date: Feb. 12, 2026

(54) METHOD AND SYSTEMS FOR CHIRP-MATCHED FIBER PARAMETRIC AMPLIFICATION

(71) Applicant: UNIVERSITY OF ROCHESTER, Rochester, NY (US)

(72) Inventors: William RENNINGER, Rochester, NY (US); Zhenhua GUO, Rochester, NY (US); Sarat TIRUMALA, Rochester, NY (US)

(21) Appl. No.: 19/286,647

(22) Filed: Jul. 31, 2025

Related U.S. Application Data
(60) Provisional application No. 63/681,996, filed on Aug. 12, 2024.

(51) Int. Cl. H01S 3/094; H01S 3/067; H01S 3/10

(52) U.S. Cl. CPC H01S 3/094076; H01S 3/06754; H01S 3/094003; H01S 3/094042; H01S 3/10084

(57) ABSTRACT

By matching relative chirps of pump and seed pulses, precise phase matching is achieved between temporally local pump and seed frequencies across all locations in the pulse overlap resulting in substantial energy conversion from high energy pump pulses at 1035 nm to seed pulses at 1300 nm with an efficiency of more than 20%. This technique, called Fiber Parametric Chirp-Matched Amplification (FPCMA), uses microstructured PCFs as the parametric gain medium pumped by a Yb-CPA laser and is efficient, energy scalable and can be designed for amplification at any wavelength, enabling MW-scale peak powers at previously inaccessible wavelengths in fiber.

This application claims priority from U.S. Provisional Application No. 63/681,996, filed Aug. 12, 2024, which is incorporated herein by reference.

This invention was made with government support under grant numbers EB028933, awarded by the National Institutes of Health. The government has certain rights in the invention.

### FIELD

This application relates to the field of ultrashort pulse laser applications, in particular applications of chirp-matched amplification.

### BACKGROUND

Several wavelength-specific ultrashort pulse applications are not well serviced by traditional mode-locked lasers systems, which are restricted to the efficient emission bands of their gain media. For example, while high peak power sources near 1300 nm are particularly desirable for deep tissue nonlinear bioimaging, access to this performance generally requires a complex and prohibitively expensive system.

Fiber Optic Parametric Chirped Pulse Amplification (FOPCPA) potentially enables a wavelength-flexible approach to ultrashort pulse generation with the robust and low-cost benefits of fiber. FOPCPA with the tailorable dispersion profiles of photonic crystal fibers (PCF) and normal dispersion pumping enables the phase-matching conditions required to achieve a wide signal wavelength separation from an efficient but fixed pump. However, the high peak powers most desirable for applications have not yet been demonstrated with this approach.

To achieve the most efficient parametric conversion, a precise relationship is required between the chirp of the pump and seed, such that phase matching occurs at all points in time where different pump and signal wavelengths overlap. This chirp matching requirement is challenging to achieve given practical experimental constraints.

### SUMMARY

An aspect of the present application is directed to a system for fiber optic parametric-chirped pulse amplification (FOP-CPA) comprising: a pump source, wherein the pump source comprises a pump dispersive device and a pump amplifier and wherein the pump source generates a chirped and amplified pump ultra-fast pulse; a seed source, wherein the seed source is synchronized to the pump source and generates a chirped seed ultra-fast pulse; a fiber parametric-chirp matched amplification (FPCMA) fiber, wherein the FPCMA fiber receives the chirped and amplified pump ultra-fast pulse and the chirped seed ultra-fast pulse, and wherein the chirped and amplified pump ultra-fast pulse and the chirped seed ultra-fast pulse have been path-matched and chirp-matched, wherein the chirp-match is at a fixed ratio of the chirped and amplified pump ultra-fast pulse to the chirped seed ultra-fast pulse as prescribed by an alignment point on a slope of a fiber dispersion curve for the fiber being used in the system; and an output, wherein the output receives a chirp-matched amplified ultra-fast pulse from the FPCMA fiber, wherein the chirp-matched amplified ultra-fast pulse is dechirped to become an output signal centered at the targeted frequency and having a higher energy than the chirped seed ultra-fast pulse

An aspect of the application is directed to a method for fiber optic parametric-chirped pulse amplification (FOP-CPA) comprising: generating ultra-fast pulses of light centered at a targeted frequency from a pump source; generating a chirped pump signal, wherein the chirped pump signal is generated from the ultra-fast pulses; generating a chirped seed signal, wherein the chirped seed signal is generated from a fraction of the ultra-fast pulses that generated the chirped pump signal or from an independent seed source that is synchronized electrically to the pump source; transferring the pump signal and the seed signal with a delay line to a fiber parametric-chirp matched amplification (FPCMA) fiber, wherein the pump signal and seed signal are path-matched; chirp-matching the pump signal with the seed signal to amplify the seed signal through the FPCMA fiber, wherein a chirp-matched amplified ultra-fast pulse is an output signal from the FPCMA fiber; and dechirping the output signal, wherein the dechirped output signal centered at the targeted frequency and having a higher energy than the seed signal.

These and other aspects, objects, features, and advantages of the example embodiments will become apparent to those having ordinary skill in the art upon consideration of the following detailed description of example embodiments.

### BRIEF DESCRIPTION OF THE DRAWINGS

FIGS. 1A-1F show FPCMA theory and design. FIG. 1A: Conversion efficiencies for different pump and signal wavelengths are plotted with best efficiency points highlighted in red. Each pump wavelength has a corresponding ideal phase matched signal wavelength (dashed lines). FIG. 1B: Linearly upchirped Pump and downchirped signal pulses are shown in the time domain such that each pump wavelength temporally overlaps with its corresponding phase matched signal wavelength at all points across the pulse (black dumbbells connecting to colorbar) to result in FIG. 1C, showing zero local phase mismatch at all points across the pulse overlap. FIG. 1D: Design schematic for the FPCMA system. Starting with a target signal wavelength and BW, a fiber is chosen which enables use of a desirable pump (Yb-CPA). A low power seed at the target wavelength, and a high-power pump are then chirp-matched, synchronized and then coupled into the fiber. The ratio of chirps is set by the slope of the phase matching curve. FIG. 1E flowchart outlining the design process with output parameters listed in FIG. 1F

FIG. 2 shows: Simplified experimental schematic of FPCMA system. A high power Yb-CPA pump is generated at 1035 nm and a small fraction of the pump is used to generate a seed at 1300 nm by SSFS. The pump and seed chirps are matched before they are temporally synchronized and launched into a PCF where parametric amplification takes place. The output amplified signal is dechirped to yield an ultrashort pulse at 1300 nm. PBS: polarizing beam splitter, λ/2: Half wave plate, λ/4: Quarter wave plate, ISO: isolator, AOM: Acousto Optic Modulator, PBS: Polarizing beam splitter, DM: Dichroic mirror.

FIG. 3A-3D show parameter optimization for FPCMA system. Measured (blue circles) and numerically modeled (blue curves) energy conversion efficiencies as well as measured (green crosses) and numerically modeled (green curves) RMS spectral bandwidths are plotted for small variations of different parameters-relative delay (FIG. 3A), seed center wavelength (FIG. 3B), seed chirp (FIG. 3C) and fiber length (FIG. 3D). Good agreement between data and simulations is observed overall. Insets for each parameter show a cartoon representation of that particular parameter.

FIG. 4A-4D show: FIG. 4A: Measured spectrum (green) and numerical model (red). FIG. 4B: Measured autocorrelation (green) and numerical model (red) showing side pulses in measurement (inset). FIG. 4C: Simulated spectrum accounting for side pulses (red) and FIG. 4D: Numerical autocorrelation (red) with inset showing side pulses.

FIGS. 5A-5B show polarization detuning causes suppression of backconversion. FIG. 5A: When the amplification is in unsaturated condition, co-polarized signal and pump leads to best efficiency (green circles). When the amplification is in saturated mode (red crosses), a slight detuning of the seed polarization away from the co-polarized case increases conversion efficiency. FIG. 5B: A basic heuristic model qualitatively reproduces this behavior.

FIGS. 6A-6D show peak power validation. FIG. 6A: Spectral broadening data shows >80% of pulse energy contributes to peak power. FIG. 6B: Image of microglia cells (green dots) at a depth of 100 μm in mouse brain. FIG. 6C shows attenuation length measurement. FIG. 6D show an experimental setup for a “home-made” 3-photon microscope.

While the present disclosure will now be described in detail, and it is done so in connection with the illustrative embodiments, it is not limited by the particular embodiments illustrated in the figures and the appended claims.

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

### Overview

The present application demonstrates numerical designs and experiments for achieving high efficiency Fiber Parametric Chirp-Matched Amplification (FPCMA) at high energies. Experimentally relevant parameters such as relative delay mismatch, chirp-mismatch, center wavelength mismatch and length of the parametric gain fiber are critical to achieving precise phase-matching between the pump and seed pulses which results in high efficiency of energy transfer. Careful comprehensive numerical simulations were performed to understand individual parameter's effects on system performance, and this guided their optimization. A novel effect of back-conversion due to relative polarization detuning is also discussed.

Using a raman-soliton shifted seed at 1300 nm pumped with a high energy Yb-CPA pump, broadband pulses dechirpable to 180 fs with 450 nJ of pulse energy centered at 1310 nm are obtained at a 1 MHz repetition rate. High pump-photon conversion efficiency of >52% (26% each to signal and idler) corresponding to >21% energy conversion efficiency (Esignal/Epump) is obtained. Peak power of the compressed pulses is validated using spectral broadening in SMF, and 3-photon imaging of mouse brain cells is performed.

### Theory

FPCMA enables exact phase matching between pump and seed pulses at every point in the temporal overlap. Phase-matching conditions for efficient FWM are given by 2ωₚ=ωₛ+ωᵢ and 2kₚ−kₛ−kᵢ=Δk=0, where ωₚ, ωₛ, ωᵢ are the frequencies and kₚ, kₛ, kᵢ are the wavevectors of the pump, signal and idler respectively. Following the standard analysis (Pitois et al., Opt Commun 226, 415-422 (2003); Fu et al., J. Opt. Soc. Am. B. 37, 1790-1805 (2020)), the signal and idler frequencies can be expressed in terms of an offset from the pump frequency ωₚ as, Ω=ωₚ−ωₛ=ωᵢ−ωₚ. Expressing the total dispersion in fiber β(ω) as a Taylor expansion about the pump frequency ωₚ and accounting for nonlinear phase changes, the phase matching condition can be given as:

$$Δ k = {β}_{2} Ω + \frac{1}{12} {β}_{4} {Ω}^{4} + 2 γ {P}_{0} = 0 \qquad ( 1 )$$

, where γ=n₂ωₚ/cA_{eff} is the nonlinear parameter and P₀ is the peak power of the pump, and higher order coefficients β₆, . . . have been ignored. Solving for Ω yields,

$${Ω}_{0}^{2} = - \frac{6 {β}_{2}}{{β}_{4}} ( 1 + \sqrt{1 - \frac{2 {β}_{4} γ {P}_{0}}{3 {β}_{2}^{2}}} ) \qquad ( 2 )$$

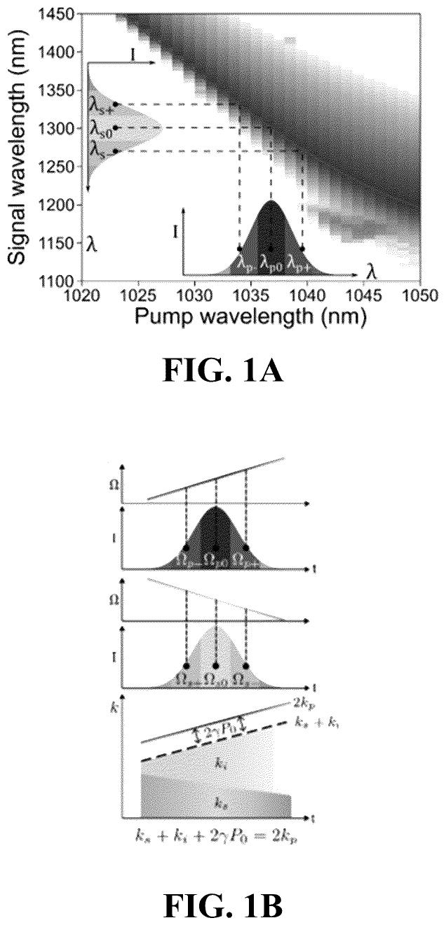

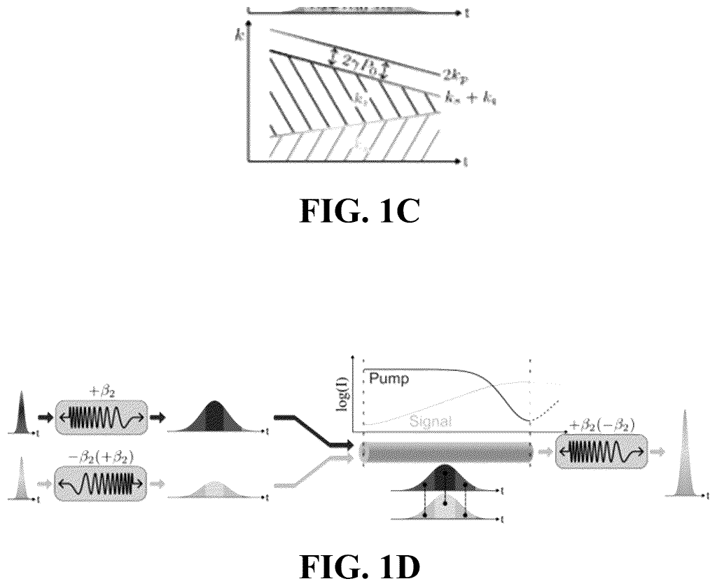

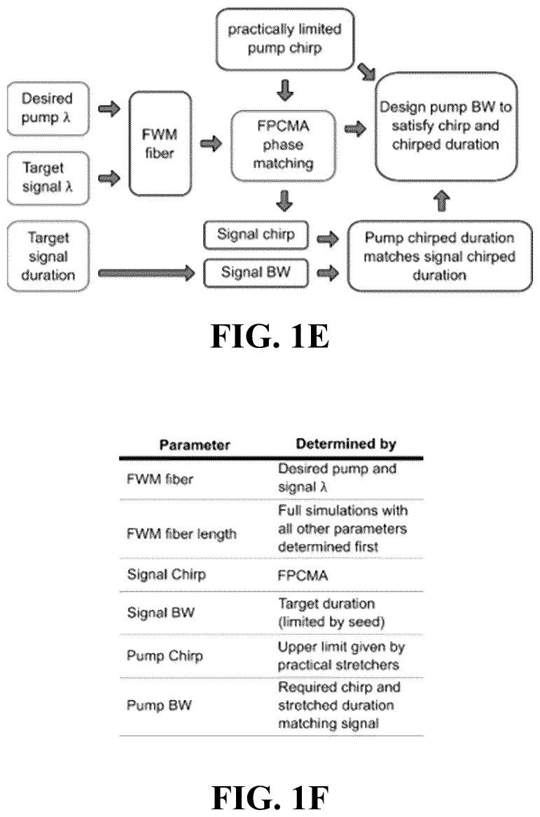

for the normal dispersion case (β₂>0, β₄<0). Plotting the phase matched wavelengths for different pump wavelengths yields the phase matching curve. However, this analytic calculation assumes monochromatic CW beams with the undepleted pump approximation. Realistic simulations with pulses and accounting for pump depletion effects are obtained by numerically solving the coupled amplitude Generalized Nonlinear Schrodinger Equations (GNLSE) (Agrawal, Nonlinear fiber optics (Elsevier/Academic Press, 2013)), to yield a phase matching map and a realistic phase matching curve which is just the line connecting the best efficiency points on the map (FIG. 1A). For chirped pulses, the different wavelength components are dispersed in time (FIG. 1B), and since the phase matching curve is linear over small frequency ranges, all the wavelengths in a linearly chirped pump pulse can simultaneously optimally phase match to all the wavelengths in a linearly chirped signal pulse, when the chirps are matched to the slope of the phase matching curve at those wavelengths (FIG. 1C). The dispersion curve of the fiber determines this slope, and in this case, it is negative, requiring the pump and seed to have opposite chirps. With the appropriately chirped pump and seed input into the nonlinear FWM fiber, efficient amplification occurs yielding an energetic amplified signal with the chirp unchanged from the input (FIG. 1D). The leftover depleted pump is filtered out and the amplified signal is appropriately dechirped to obtain the desired high peak power ultrashort pulses at the target signal wavelength.

The essential parameters for FPCMA (FIG. 1f table) can be designed for a wide range of wavelengths and pulse parameters following a straight-forward design path (FIG. 1e flow chart), in which the pump bandwidth, specific FWM fiber and its optimum length are determined starting from a target signal pulse duration at a target wavelength with desirable pumps chosen and constrained by practically achievable chirping limits. This is illustrated by the design for the experimental system presented here. In this study, the aim is to develop pulse sources suitable for deep tissue bio-imaging, an extremely wavelength-sensitive field currently constrained by the high cost and complexity of free-space pulse sources which limit wider adoption and slow down research. The ideal wavelength for bioimaging is around 1300 nm because of large penetration depths, low tissue absorption and ability to target common fluorophores like GFP (Wang et al., IEEE Journal of Selected Topics in Quantum Electronics 20 (2014)).

Since the technique used for imaging is multi-photon microscopy, high peak power pulses in the 1300 nm band are desired. The choice of nonlinear fiber is then determined by the target wavelength and the pump wavelength used. Since Yb is an excellent gain medium characterized by low quantum defect, simple electronic level structure and large gain bandwidth, it serves as an excellent pump in the 1 μm region. Since pumping in the normal-dispersion regime is desired, this leads us to a commercial PCF having a zero-dispersion wavelength (ZDW) at about 1040 nm (SC-5.0-1040, NKT Photonics). The phase matching curve of the fiber predicts that a pump centered at ˜1035 nm is matched to a signal centered at ˜1300 nm. The study constructed a Yb-CPA system to generate a high power pump. The pump chirp is maximized to benefit a high-power Yb-CPA system but is practically limited by available stretchers to ˜20 ps². Then, following the FPCMA recipe (FIG. 1e), the chirp-matching relationship sets the signal chirp for optimum phase matching, which is about −3.5 ps². A target signal duration of 50 fs combined with the required signal chirp fixes the stretched signal duration, which must match the stretched pump duration for maximal energy transfer.

Therefore, the study identifies a unique pump bandwidth of about 5 nm that meets the specified requirements for chirp and stretched pulse duration. It's important to note here that typically Yb-CPA systems are designed to maximize bandwidth and the design requirement aiming for a particular output bandwidth does not coincide with conventionally optimum CPA designs. Finally, numerical simulations of parametric amplification between pump and seed pulses with target wavelengths, bandwidths and chirps are performed using the nonlinearity and dispersion coefficients of the chosen fiber for different pumping energies to determine the ideal fiber length resulting in maximum conversion efficiency at the output. The numerical simulations are described in detail later in the Examples section.

Generating a seed pulse for an FPCMA design at a target wavelength and desired bandwidth is not trivial. An ideal seed source should enable the seed to adopt a linear chirp profile that can be easily adjusted to satisfy chirp-matching, allow precise tuning of the center wavelength while maintaining consistent broad bandwidth and facilitate uncomplicated means of synchronization with the pump. The SSFS process is perfectly suited to produce such a seed. It allows for continuous wavelength tuning by adjusting the coupled power, resulting in a transform-limited soliton at the fiber output that can be conveniently down-chirped with a grating pair stretcher. Furthermore, using a common oscillator for generating both pump and seed offers the benefit of passive pulse synchronization through matching the optical path length, as well as enable potential carrier envelope offset stabilization if required by future applications.

### Design

While FPCMA is in principle extremely power scalable, bulk and surface damage can occur in fiber due to high optical power. For pulses longer than 100 ps, damage is caused by irradiance and not fluence. Bulk threshold irradiance for such longer pulses for pure silica has been reported as 4.75 kW/um\hat{ }2 (Smith et al., Appl. Opt. 47, 4812-4832 (2008)). Typically, surface damage thresholds are nearly always reported to be 2-5 times lower than bulk thresholds. Polishing of the surface can improve this threshold to about 50% of the bulk value (Smith et al., Appl. Opt. 47, 4812-4832 (2008)). This sets an upper limit of safe irradiance to be about 2.5 kW/um\hat{ }2 which is near the current value of 1.3 kW/um\hat{ }2. A PCF endcap can be used to avoid surface damage, but pulse energy can effectively be scaled only by using larger mode areas (provided by an LMA PCF) while staying under bulk damage thresholds. Stokes light buildup due to parasitic SRS is also a potential problem when scaling up pump energy in a Yb-CPA system. Shorter amplifier fibers and more amplification stages can be added to scale pump energies to 100 μJ or higher.

Polarization control can be beneficial by eliminating side pulses as well as increasing overall system stability and repeatability. Since the system involves fiber coupling and outcoupling for both seed generation and parametric amplification, it is sensitive to environmental conditions like temperature, pressure, dust, etc. While the Yb-CPA pump can be easily converted to all-fiber, it is more challenging to obtain a linearly chirped seed in fiber. Since SSFS needs dechirped pulses coupled into a nonlinear PCF, using a fiber dechirper for the pump can easily lead to undesirably high B-integrals. While seed chirp, wavelength and delay can easily be finely adjusted in free space, the constraints of an all-fiber system make such adjustments cumbersome (by using fiber cutbacks for example). Finally, coupling a high-powered pump and a low powered seed into the same PCF in fiber is challenging and needs development of custom couplers to maximize coupling and minimize undesirable nonlinear effects. While an all-fiber system certainly has advantages, the partial-free space design of this system permits us to quickly implement design changes and achieve fast optimization of final output performance.

While this pump bandwidth can support broadband amplification across ˜50 nm of seed, the study is currently limited by the available seed bandwidth generated by the SSFS process. After chirp-matched with the pump, the current bandwidth of 22 nm results in the stretched seed pulse to be only 85 ps long as compared to 160 ps pulse duration of the stretched pump. The reduced temporal overlap caused by this pulse-duration mismatch is the main reason for the reported photon conversion efficiency of only 26%. Using a seed with a broader spectral bandwidth (50 nm) when chirp-matched with the pump results in both pulses having same stretched pulse durations ensuring maximum energy conversion. The broader input seed also results in broader output which can be compressed to <50 fs pulse durations. Some avenues to obtain a broader seed include a different fiber for SSFS, filtering supercontinuum, kerr resonators, etc.

FPCMA technique is theoretically applicable to any wavelength since it does not intrinsically depend on any material properties. However, a high power chirped pump is needed with a fiber that has normal dispersion at the pumping wavelength. Dispersion shifted fibers with normal dispersion at 1550 nm already exist allowing Chirp-Matching to be implemented at that wavelength using a Er-doped fiber pump. Just using pumps at 1 μm and 1.5 μm, generating energetic pulses in the 0.5-2 μm range is straightforward with existing available PCFs. For other pumping wavelengths at 2 um and beyond further fibers are needed for suitable dispersion. Since the field of dispersion engineering in microstructured PCFs is rapidly growing, it is expected that there shall be widespread applicability and use of FPCMA to produce wavelength agile energetic ultrashort pulses in fiber.

The methods and systems described herein are theoretically applicable to any wavelength since it does not intrinsically depend on any material properties. Embodiments of the methods and systems described herein may be used, without limitation, for applications such as micromachining, ophthalmology, precision metrology and biomedical imaging. In particular embodiments, the methods and systems described herein are used in deep tissue multiphoton microscopy.

One of ordinary skill in the art will understand that there are a variety of means to obtain pulses at novel wavelengths in fiber, such as, without limitation, SPM enabled Spectral Selection (SESS), soliton self-frequency shifting (SSFS), fiber optic parametric oscillators (FOPO), and fiber optic parametric amplifiers (FOPA). One of ordinary skill will understand that FOPAs need to be seeded.

Further embodiments of the methods and systems described herein may include seed bandwidth scaling with shorter pulses and higher efficiency, all polarization-maintaining architecture with no side pulses and better environmental stability, and higher energy output with fiber endface damage, stimulated Raman scattering (SRS) suppression, and larger stretching ratios.

One of ordinary skill will understand that the pump source can be from any efficient fiber source, such as Yb, Er, Tm, Ho or others.

One of ordinary skill will understand that the low energy seed source does not have to be derived from the pump, it can be a standalone low energy source that is only synchronized to the pump. Examples are Kerr resonators or intensity and phase modulated sources.

One of ordinary skill will understand that the gratings can be: diffraction gratings, fiber gratings, volume gratings, or a suitable long length of dispersive fiber.

One of ordinary skill will understand that the four wave mixing fiber can be standard fiber, or photonic crystal fiber with solid core or hollow core or hollow core filled with a liquid or gas.

An aspect of the present application is directed to a system for fiber optic parametric-chirped pulse amplification (FOP-CPA) comprising: a pump source, wherein the pump source comprises a pump dispersive device and a pump amplifier and wherein the pump source generates a chirped and amplified pump ultra-fast pulse; a seed source, wherein the seed source is synchronized to the pump source and generates a chirped seed ultra-fast pulse; a fiber parametric-chirp matched amplification (FPCMA) fiber, wherein the FPCMA fiber receives the chirped and amplified pump ultra-fast pulse and the chirped seed ultra-fast pulse, and wherein the chirped and amplified pump ultra-fast pulse and the chirped seed ultra-fast pulse have been path-matched and chirp-matched, wherein the chirp-match is at a fixed ratio of the chirped and amplified pump ultra-fast pulse to the chirped seed ultra-fast pulse as prescribed by an alignment point on a slope of a fiber dispersion curve for the fiber being used in the system; and an output, wherein the output receives a chirp-matched amplified ultra-fast pulse from the FPCMA fiber, wherein the chirp-matched amplified ultra-fast pulse is dechirped to become an output signal centered at the targeted frequency and having a higher energy than the chirped seed ultra-fast pulse.

In some embodiments, the pump dispersive device is selected from the group consisting of fiber, a dispersive grating pair, and chirped fiber-bragg gratings.

In some embodiments, the seed source is (1) connected to the pump source and receives a fraction of a chirped pump ultra-fast pulse from the pump source, or (2) an independent light source that is synchronized electrically to the pump source, wherein the seed source comprises a seed frequency shifter. In some embodiments, the seed frequency shifter is selected from the group consisting of soliton self-frequency shift (SSFS) fibers, filtered superconinuum fibers, cascaded Raman fibers, and soliton self-mode conversion fibers. In some embodiments, the seed source is an independent light source selected from the group consisting of mode-locked lasers, kerr resonators, and electrically generated sources. In some embodiments, the seed source further comprises a seed dispersive device for chirp matching. In some embodiments, the seed source further comprises an additional dispersive device that dechirps the chirped seed stemming from the pump.

In some embodiments, the seed dispersive device is selected from the group consisting of fibers, a dispersive grating pair, and chirped fiber-bragg gratings.

In some embodiments, the system further comprises an oscillator, wherein the oscillator generates ultra-fast pulses of light centered at a targeted frequency and wherein the pump source is connected to the oscillator and receives the ultra-fast pulses at the target frequency from the oscillator. In some embodiments, the oscillator is used for both the pump source and the seed source, and wherein the chirped and amplified pump ultra-fast pulse and the chirped seed ultra-fast pulse are passively synchronized by matching their optical path length.

In some embodiments, the system further comprises a delay line, wherein the delay line is connected to the pump source and receives the chirped and amplified pump ultra-fast pulse from the pump source, or wherein the delay line is connected to the seed source and receives the chirped seed ultra-fast pulse from the seed source, and wherein the FPCMA fiber receives the chirped and amplified pump ultra-fast pulse from the pump source and the chirped seed ultra-fast pulse from the seed source.

In some embodiments, the pulse source further comprises a pulse picker. In some embodiments, the pulse picker is an acousto-optic modulator (AOM), wherein the AOM receives the chirped pump ultra-fast pulse from the pump dispersive device and wherein the pulse picker reduces the repetition rate of the chirped pump ultra-fast pulse.

In some embodiments, the pump amplifier comprises a preamplifier and a large mode area fiber amplifier.

In some embodiments, the system comprises a frequency selective filter, wherein the filter selects for the amplified seed signal.

In some embodiments, the chirped pump ultra-fast pulse from the pump source is an up-chirped pump ultra-fast pulse and wherein the chirped seed ultra-fast pulse from the seed source is a down-chirped seed ultra-fast pulse.

In some embodiments, the chirped pump ultra-fast pulse from the pump source is a down-chirped pump ultra-fast pulse and wherein the chirped seed ultra-fast pulse from the seed source is an up-chirped seed ultra-fast pulse.

In some embodiments, the chirped pump ultra-fast pulse from the pump source is an up-chirped pump ultra-fast pulse and wherein the chirped seed ultra-fast pulse from the seed source is an up-chirped seed ultra-fast pulse.

In some embodiments, the chirped pump ultra-fast pulse from the pump source is a down-chirped pump ultra-fast pulse and wherein the chirped seed ultra-fast pulse from the seed source is a down-chirped seed ultra-fast pulse.

In some embodiments, the chirp-matched amplified ultra-fast pulse is dechirped with a dispersive device.

An aspect of the application is directed to a method for fiber optic parametric-chirped pulse amplification (FOP-CPA) comprising: generating ultra-fast pulses of light centered at a targeted frequency from a pump source; generating a chirped pump signal, wherein the chirped pump signal is generated from the ultra-fast pulses; generating a chirped seed signal, wherein the chirped seed signal is generated from a fraction of the ultra-fast pulses that generated the chirped pump signal or from an independent seed source that is synchronized electrically to the pump source; transferring the pump signal and the seed signal with a delay line to a fiber parametric-chirp matched amplification (FPCMA) fiber, wherein the pump signal and seed signal are path-matched; chirp-matching the pump signal with the seed signal to amplify the seed signal through the FPCMA fiber, wherein a chirp-matched amplified ultra-fast pulse is an output signal from the FPCMA fiber; and dechirping the output signal, wherein the dechirped output signal centered at the targeted frequency and having a higher energy than the seed signal.

In some embodiments, the center wavelength of the chirped pump signal is matched with the phase matched frequency of the chirped seed signal.

In some embodiments, the chirp-matching is at a fixed ratio of the chirped pump signal to the chirped seed signal as prescribed by an alignment point on a slope of a fiber dispersion curve for the FPCMA fiber.

The present application is further illustrated by the following examples that should not be construed as limiting. The contents of all references, patents, and published patent applications cited throughout this application, as well as the Figures and Tables, are incorporated herein by reference.

### EXAMPLES

### Example 1: Methods

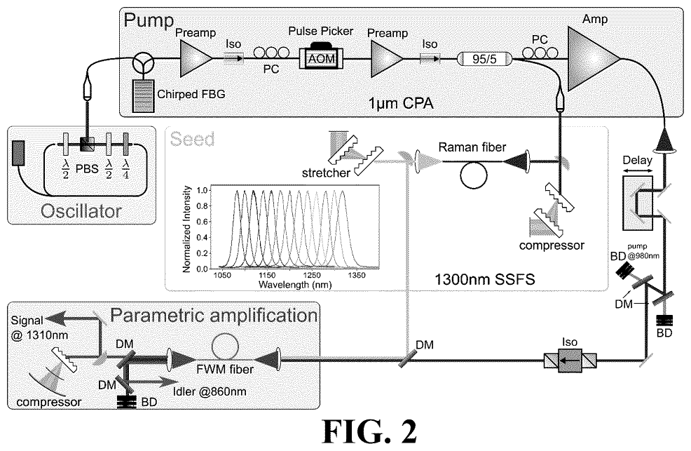

The experimental FPCMA system (FIG. 2) begins with a Yb-doped stretched pulse mode-locked fiber oscillator (Tamura et al., Opt Lett 25, 442-444 (2000)). The spectral bandwidth of the pulses in the oscillator is set by the net dispersion of its cavity which is adjusted using an intra-cavity grating pair to obtain ˜5 nm (FWHM) pulses at 1035 nm (1035.5 nm centroid), as required by the design. The pulse repetition rate is 39 MHz with a total output average power of 9.5 mW. From the oscillator, the pulses are then up-chirped by a Chirped Fiber Bragg Grating (CFBG) (Teraxion-TPSR) which imparts GDD and TOD values of 20.72 ps² and −0.32 ps³ respectively, stretching them to ˜180 ps. The stretched pulses are amplified by a Yb-doped preamplifier to an average power of about 200 mW before they are pulse picked to reduce the repetition rate down to 1 MHz. The pulse picker is triggered and synchronized by a fundamental repetition rate signal of the oscillator which is obtained by placing a photodetector at a weak reflected beam from one of the gratings in the cavity. Due to the large insertion loss and the reduction in repetition rate, the average power after the pulse picker is about 2 mW. The pulses are then amplified again in a second preamplifier to an average power of 200 mW before a small fraction (5%) of power is split away to generate the seed. The remaining fraction of 95% is then amplified further in a Yb-doped Large Mode Area (LMA) fiber with a 30 μm core diameter (LMA-YDF-30/250-9M, Coherent) to a final output average power of about 5 W (pulse energy ˜5 μJ) and acts as the pump for the parametric amplification. While the increased mode area reduces undesirable B-integral accumulation, it also introduces higher-order modes.

Single mode beam quality can be achieved by coiling the fiber tightly around a mandrel (Koplow et al, Opt Lett 25, 442-444 (2000)), which introduces significant bend losses to all but the lowest order modes. To choose the correct bend diameter, we calculated the bend losses of higher order modes for different bend radii using a simple numerical analysis in COMSOL (Schermer et al, Ieee J Quantum Elect 43, 899-909 (2007)) and chose the diameter for which the bend loss/m of the LP11 mode is higher than the amplifier gain/m it experiences (Huang et al., J Opt Soc Am B 33, 1030-1037 (2016)). At this bend diameter of 7.5 cm, all higher order modes of LP11 and higher attenuate rapidly and result in near-single mode beam quality which was measured to have an M\hat{ }2 of 1.1. At the output of the main amplifier, the leftover 976 nm amplifier pump is filtered out by a combination of index matching gel and a dichroic mirror.

For the signal seed, the 5% fraction is dechirped back to transform limit with a grating compressor and coupled into a 1 m piece of highly nonlinear PCF (NL-1.7-700, NKT Photonics) where SSFS takes place. The magnitude of wavelength shift can be varied by adjusting the coupled power (using a polarizing beam splitter and a half-wave plate) and is set such that the center wavelength of the furthest red-shifted band is at ˜1300 nm, which is the target design wavelength (FIG. 2 inset). An optimum balance between the target design wavelength and stability of the shifted soliton is reached at a center wavelength of 1310 nm. The bandwidth of the shifted soliton is measured to be about 22 nm, with a sech2 spectral profile. This unchirped soliton with pulse energy of 60 pJ and duration of 82 fs is selected by a 1250 nm high pass filter and linearly downchirped to a stretched duration of 80ps by another grating pair stretcher. Although the FPCMA system was designed for a larger target bandwidth, the bandwidth of the shifted soliton at a given wavelength is limited by the nonlinearity and dispersion curves of the SSFS fiber used (Gordon, Opt Lett 11 (1986)). Numerical simulations with the experimentally obtainable seed bandwidth indicate that while the designed signal chirp required to satisfy chirp matching is unaltered, the lower bandwidth results in a smaller stretched duration and a reduced overlap with the pump pulse leading to a slight compromise in conversion efficiency (see below).

The high power up-chirped pump pulse at 1035 nm and the low power down-chirped signal seed at 1310 nm are combined using a dichroic mirror, precisely path matched using a delay line and coupled into a 10 cm PCF (SC-5.0-1040, NKT Photonics) using an aspheric lens. Since the aspheric lens is not achromatic, it has different focal distances for the pump and the signal seed. The pump coupling was maximized to result in 70% coupling efficiency, while simultaneously resulting in 50% coupling efficiency for the signal seed. The relative delay between the pulses was measured using a fast photodiode detector with a 12 ps rise time (Model 1024, New Focus) connected to a 25 GHz oscilloscope (9301-25, Picoscope). The fiber was straight-cleaved at the input end to minimize fiber mounting instabilities at high powers, as well as to aid in easy coupling and the output end was angle cleaved to minimize back-reflections. A high-power isolator placed between the PCF and the main amplifier eliminated any back-reflection. The output from the PCF was collected and collimated by an aspheric microscope objective with only 5% transmission loss. The output light first passes through a 1250 nm high pass filter, which separates out the 1310 nm amplified signal and then through a 950 nm high pass filter for the idler (at 860 nm). The remaining light includes the leftover pump and is discarded into a beam dump. The amplified signal was then dechirped using a single grating offner compressor and then characterized by a spectrum analyzer and autocorrelator. Since high B-integral accumulation leads to pulse distortions, the fiber lengths were minimized where possible to limit the calculated B-integral to less than 2π. Polarization control is also very important for overall environmental stability. In addition, the relative polarization of pump and signal critically affects the FWM process (Agrawal, Nonlinear fiber optics (Elsevier/Academic Press 2013)) and is controlled by using fiber polarization controllers and waveplates throughout the system. An additional diagnostic grating pair compressor was built to verify dechirpability of the 1035 nm pump pulses.

### Example 2: Parameter Analysis

There are several experimental parameters affecting amplification dynamics in such a fiber optic parametric amplification system. Each parameter value affects the pulse evolution and dynamics of the parametric amplification, in turn influencing the effect of other parameters. This high level of interconnectedness makes it very challenging to achieve good performance without a tedious global optimization analysis. However, some important parameters such as the relative delay between the pump and seed pulses, their individual chirps, center wavelengths and fiber length have a direct influence on the output conversion efficiency and amplified bandwidth, and thus we study them to guide us towards a global performance optimum.

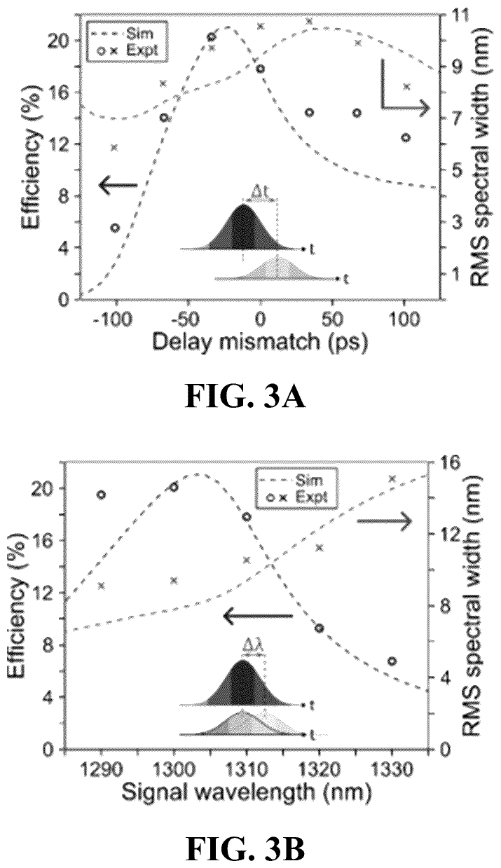

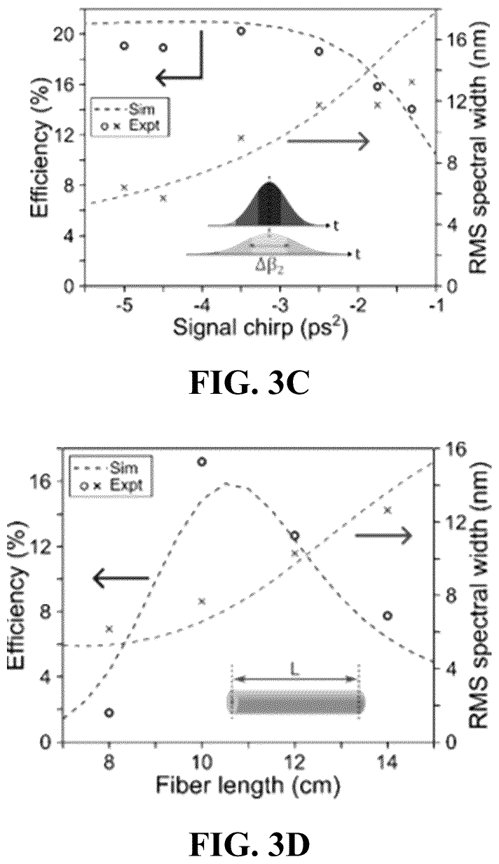

The pump center wavelength and chirp are kept fixed, while the relative delay, signal wavelength, signal chirp and fiber length are varied over a small range centered on their respective design values. For each set of these parameter values, the output conversion efficiency and amplified spectrum is measured for several different pump powers, to account for backconversion effects that may occur at high pump powers, and the best efficiency among these is recorded and plotted in FIGS. 3A-3D (blue circles). The energy efficiency of conversion was calculated as a ratio of output amplified average power of the signal to the input pump average power coupled into the fiber. The root mean square spectral bandwidth is calculated for the spectrums corresponding to these best efficiency points and is also plotted in FIGS. 3A-3D (green crosses). Interestingly, the value of the experimental pump power which yields the best efficiency for each set of parameter values is very consistent across each parameter range as well as across the different parameters, varying only about 5% around 2.1 μJ. Likewise, full system numerical simulations closely replicating experimental conditions are performed to evaluate the accuracy of modeling the effect of these different parameters on system performance. In these simulations, the study used gaussian pump pulses with center wavelength, bandwidth and chirp matching experimental conditions, and sech² signal pulses (due to it being a soliton) also with experimentally consistent bandwidth, and numerically propagate them in a 10 cm length of FWM fiber. Each parameter is varied smoothly in the same range as used for the experiments, and the same value of experimental pump power corresponding to the best efficiency for the entire parameter range is used in the simulations (see below on parameter uncertainty). The efficiency and rms spectral bandwidths are plotted in comparison to the experimental values (FIGS. 3A-3D, blue and green curves respectively).

Analyzing these plots, for co-polarized pump and seed pulses, centered at 1035 nm and 1310 nm respectively, for a fiber length of 10 cm and with chirps nearly matched, the peak of efficiency was found at a slightly non-zero value of relative delay (FIG. 3A). When the delay was fixed at zero and the signal wavelength was varied, the peak was found to be roughly at 1303 nm (FIG. 3B). Thus, the correct phase-matched center wavelength of the signal is at 1303 nm. Further experiments confirmed that a slight mismatch in relative delay can be corrected with a mismatch in wavelength (and vice-versa), due to the fact that a relative delay causes a shift in the overlapping frequencies of the chirped pulse, and this explains the location of the peak in FIG. 3A. Furthermore, the amplified spectrums show that a seed with center wavelength redshifted from the optimum experiences a higher parametric gain (but not higher overall conversion efficiency) and thus has a broader spectrum at the output of the fiber (FIG. 3B). This complicated dependence of the spectral shape with relative delay and center wavelength results in the broadest spectrum also at a non-zero delay value (FIG. 3A). Next, the chirp of the seed was varied by adjusting the separation between the grating pair after the raman fiber.

Controlling for the relative delay at 0 and the center wavelength at 1310 nm, the efficiency drops off sharply for underchirped pulses while reducing much more gently for overchirps (FIG. 3C). The output amplified spectrum gets broader as the magnitude of chirp decreases. This can be explained as follows: when the seed is underchirped relative to the chirp-matching condition, delay-matched and center wavelength is optimum, the frequency components at the wings of the stretched seed pulse are now closer to the center of the chirped pump pulse (when compared to the chirp-matched case). While these frequency components are no longer perfectly phase matched to their overlapping frequency counterparts in the pump, the higher pump intensity at the center of the pump pulse results in higher gain and thus results in a broader amplified spectrum at the output. The overall conversion efficiency across the entire signal pulse however is lower because a smaller portion of the pump participates in the amplification process with an imperfect phase match at each point.

On the other hand, for overchirped pulses, only a small subset of seed frequencies is present in the high gain region at the center of the pump pulse, and thus the amplified bandwidth is narrower. While there is still phase-mismatch in this case, the larger temporal overlap with the pump pulse results in increased pump participation and thus results in the gentle drop-off seen in the data. The optimum is found to be at −3.5 ps² of seed chirp. Finally, the peak power of the pump sets the parametric gain and how fast the signal seed is amplified. Therefore, there is an optimum fiber length beyond which back conversion effects occur. The best efficiency is at 10 cm fiber length for a pump energy of 2.1 μJ.

### Example 3: Parameter Uncertainty

While most experimental parameters are well known or can be well controlled, some are noisy with day-to-day fluctuations and others have uncertainties. For example, considering the pump pulse, the output spectrum from the oscillator is well known, as is the dispersion imparted by the CFBG and the gain experienced at each point in the amplification chain. However, the stretched temporal pulse profile of the pump measured by a fast detector varies from day to day, varying the actual peak power of the pump pulse coupled into the FWM fiber and resulting in fluctuations of output efficiency. This is hypothesized to be due to polarization dependent gain dynamics in the amplifier, which fluctuates due to uncontrolled polarization owing to the use of non-PM fiber in the system.

To account for this variation, the transform limited pump pulse duration used in the simulations was allowed to vary over a small range of 10% and the final value used for the simulations determined by the best fit to the experimental data. Similarly, the pump pulse energy for the experimental data shown in FIGS. 3A-3D has a variation of about 5% across all the parameter ranges, and thus the pump power used for the simulations is determined by the best-fit to the data, when varied over that 5% range. Finally, the quoted ZDW of the fiber is specified to ±10 nm, which can have a large variation due to the manufacturing process. To reduce this uncertainty, we measure the spectrum of the spontaneous parametric superfluorescence generated when the seed light is blocked. This measurement significantly improves the uncertainty to about ±0.5 nm, and the best fit value is used in the simulations (see SI section 4). In addition, drifts in polarization cause fluctuations in the center wavelength of the shifted soliton, which can be of the order of 5 nm over the course of an experiment, partially accounting for disagreement between simulations and data.

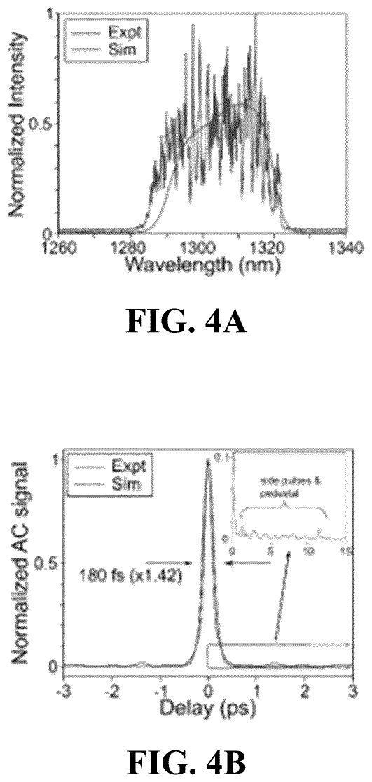

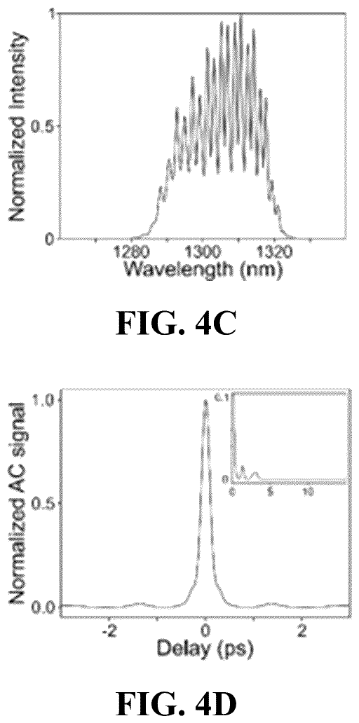

To obtain maximum conversion efficiency from the system, we started with pump and seed center wavelengths, pump chirp and pump bandwidth fixed at the nominal design values of 1035 nm, ˜1305 nm, ˜20 ps² and ˜5 nm respectively, seed chirp fixed at the simulation predicted optimum value of −3.5 ps², and a fiber length of 20 cm which was longer than predicted optimum. Each experiment run consisted of measuring the conversion efficiency as a function of increasing pump power coupled into the fiber. The best conversion efficiency obtained in each experimental run was compared for different values of relative delays between the pulses and the delay was fixed to the value resulting in the best overall efficiency. The fiber length was then cutback by 2 cm at a time and the best efficiency for each fiber length was measured, resulting in the optimum length of 10 cm for the range of available pump powers. Simulations predict that shorter fibers can yield higher efficiency for a higher pumping power with the pumping wavelength adjusted slightly to account for the slight change in phase matching conditions. After such optimization, we obtain 450 mW of average power at the 1300 nm band at the output of the PCF for 2.1 W of pump power coupled in. The amplified output signal spectrum is centered at ˜1305 nm with an RMS bandwidth of ˜10 nm (FIG. 4A green).

A single-grating Offner compressor provides the necessary positive dispersion to dechirp the down-chirped pulses to 180 fs, close to the transform limit (FIG. 4B green). Numerical predictions for the spectrum and dechirped autocorrelation are also shown (FIGS. 4A and 4B red curves). While there is good qualitative agreement, the presence of evident spectral oscillations in the experimental data merits a closer investigation. These oscillations are correlated with some side-pulses and background pedestal observed in the dechirped signal autocorrelation (FIG. 4B inset). The spectrum of the pump pulse (not shown) has a sinusoidal variation due to the presence of some side-pulses at a delay of 10.3 ps, verified by an autocorrelation (not shown). The relative intensity of these side pulses w.r.t the main pulse seems to be polarization dependent, and their origin is thought to be from a polarization sensitive component as well as higher order modes in the LMA main amplifier.

The spectral oscillations are mapped on to temporal oscillations on the stretched pulse, and these intensity variations are transferred onto the temporal profile of the amplified signal pulse resulting in side pulses and pedestals in the dechirped signal (Forget et al., Opt. Lett. 30 (2005)). To verify this effect numerically, small side pulses were added to the main pump pulse at 10.3 ps, to result in a simulated output spectrum with clear spectral fringes having good qualitative agreement with data (FIG. 4C). The simulated dechirped autocorrelation (FIG. 4D) shows a small pedestal and some side pulses (FIG. 4D, inset), whose locations are roughly consistent with experimental data and analytical theory (Dorrer, J. Opt. Soc. Am. B. 24 (2007)). Since side pulses are preferentially amplified and further distort the pulse in CPA systems in sizeable B-integral (Didenko et al., Opt. Express 16 (2008); Schimpf, Opt. Express 16 (2008)), improving the spectral quality of the pump can lead to cleaner amplified signal pulses and potentially higher conversion efficiency.

### Example 4: Back-Conversion Suppression from Polarization Detuning (BSPD)

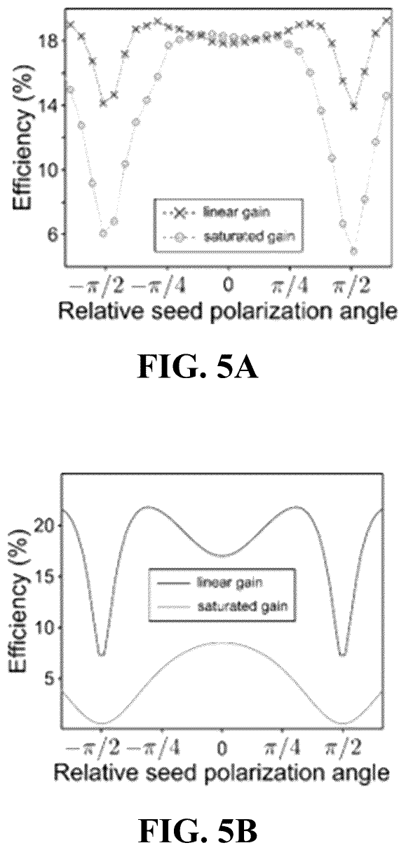

In the linear gain regime (at lower pumping power), the conversion efficiency is highest when the pump and seed beams are co-polarized (FIG. 5A, green), as expected from theory (Agrawal, Nonlinear fiber optics (Elsevier/Academic Press, 2013)). However, at a higher pump power, when the signal gain is saturated, we observed that a slight detuning of the input seed polarization away from the co-polarized condition causes an increase in conversion efficiency. This effect is symmetric in the detuning direction, resulting in a double-humped dependence on relative seed polarization angle (FIG. 5A, red). A closer look at the output spectrums reveals that the back-conversion is visibly being suppressed at the detuned polarization.

While a comprehensive vector model is needed to fully understand this phenomenon, a similar trend can be qualitatively reproduced by dividing the seed into two parts, whose intensity has a cosine² and sine² dependence on polarization angle, consistent with a rotated polarization and averaging them for each polarization angle (FIG. 5B, green and red). The interaction strength (γ) of the sine² seed, representing orthogonal polarization relative to the pump, is modeled to be 2/3rds of the strength of the cosine² seed. When the signal gain is saturated, a small portion of the input seed amplitude in the orthogonal polarization can result in more energy being extracted overall from the pump resulting in higher conversion efficiency. This effect of back-conversion suppression from polarization detuning (BSPD) motivates a more complete examination by including polarization in a full vector model of parametric amplification.

### Example 5: Peak Power Verification and Imaging

Pulse quality is one of the most important parameters of a high intensity laser system. Pulse contrast, which is critically important for laser-matter interactions is reduced by the presence of pre-pulses or pedestals which arise due to various causes as discussed in the results section. For example, in 3-photon microscopy, a cleaner pulse with all its energy contributing to the peak power can generate 4 times the fluorescence signal compared to a pulse with the same energy but having only half the peak power (Helmchen et al, Nat. Methods 2, 932-940 (2005)). Thus, a measurement of the actual peak power of the pulse can help estimate its usability for applications. While the peak power can be indirectly deduced from pulse shape measurements (for example by measuring the autocorrelation), techniques directly sensitive to pulse peak power, such as nonlinear broadening in a kerr medium, are advantageous.

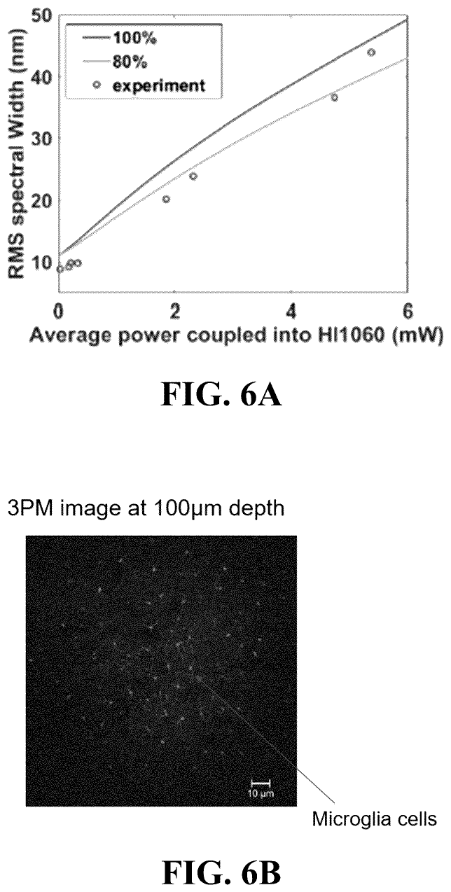

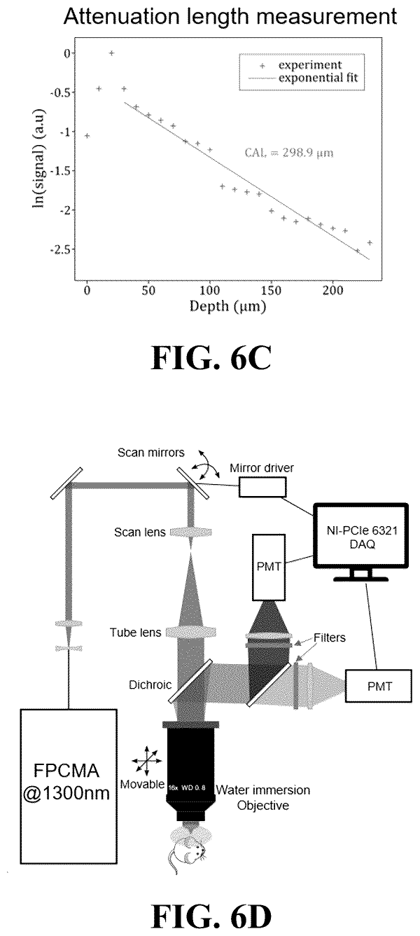

The method used here is as follows: the pulse under test (PUT) passes through a medium with kerr nonlinearity (for example, a nonlinear fiber), in which its spectrum is significantly broadened. The broadened spectrum is then recorded using a spectrum analyzer which averages over several pulses. This spectrum is recorded for different values of pulse energy and the RMS spectral widths are calculated and plotted in FIG. 6A (blue dots). Then, numerical simulations were performed using a gaussian pulse shape with a pulse duration taken from the autocorrelation measurement. Assuming 100% of the average power corresponds to pulse energy of the pulses, the numerically predicted RMS spectral width is plotted as the orange curve. Using the same pulse duration but with lower pulse energy, we find that the measured spectral broadening corresponds to about 80% of the average power contributing to the peak power of the pulse.

While the above results look promising, the suitability of the pulse source for its targeted application can truly be verified only by a trial run. Thus, a 3-photon laser scanning microscope was constructed, and the output of the FPCMA system was used as the excitation source to perform nonlinear deep-tissue imaging of auto-fluorescent microglia cells in mouse brain. As the excitation beam is raster scanned across the brain sample, 3-photon absorption of the 1300 nm light occurs at the green fluorescent protein present in the microglia cells which then emit green fluorescent light at ˜520 nm. This epi-collected fluorescence light is detected using a photomultiplier tube and recorded as a voltage value proportional to the amount of fluorescence collected. A 2-D image is formed by plotting these voltage values for each pixel in grayscale. Further, images were taken at different depths below the surface of the brain sample and the Characteristic Attenuation Length (CAL) was determined to be about ˜300 μm, which is consistent with previously reported results. An example image at a depth of about 100 μm is shown in FIG. 6B.

Spectral broadening data for different coupled powers into HI1060 fiber indicate that >80% of the pulse energy contributes to the peak power (FIG. 6A). 3-photon imaging of Cx3Cr1-GFP mouse brain which contains microglia cells expressing EGFP is shown (FIG. 6B). A home-made custom 3-photon microscope was built with a galvo-galvo scanner (Saturn 5B-ScannerMax) (FIG. 6D). The raster-scanned beam was focused onto the surface of the brain by a water-immersion 16× objective with 0.8 NA (N16XLWD-PF-Nikon). A 705 nm dichroic (FF705-Di01-25x36 Semrock) was used to collect the epifluorescence signal which was then filtered using a 520+/ −60 nm bandpass filter (FF01-520/60-25 Semrock) and detected by a GaAsP PMT with a quantum efficiency (QE) of ˜40% (at 550 nm) (PMT 2101 Thorlabs). The objective was mounted on a movable head and vertically translated using a programmable linear stage (Newport) to change the imaging depth. The FOV was set at 150 μm×150 μm. The scanning and acquisition was controlled through a PC running a free version of the ScanImage software. The current from the PMT was amplified using the built-in transimpedance amplifier with software-controllable gain. The voltage signal was then low-pass filtered (250 KHz) and analog to digital (ADC) sampling was done by a Data Acquisition card (PCIe-6321 National Instruments) at a rate of 250 Khz. Since the repetition rate of the laser is low, the pixel dwell time was ˜12 μs. With 256×256 pixels per frame, a frame-rate of 0.6Hz was achieved. Each image was averaged over 25 frames. A median filter with a 1-pixel radius was applied (FIG. 6B). A z-stack was performed with 10 μm depth increments. The Characteristic Attenuation Length (CAL) is defined as the depth at which the fluorescence signal of the top 1% pixels attenuates by 1 e³ (FIG. 6C).

Accordingly, Fiber Parametric Chirp-Matched Amplification (FPCMA) has been presented using an energetic Yb-CPA pump, soliton shifted seed and commercial PCF resulting in highly efficient broadband amplification producing >2 MW peak power in fiber at the biologically relevant 1300 nm band.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. A system for fiber optic parametric-chirped pulse amplification (FOP-CPA) comprising:
a pump source, wherein the pump source comprises a pump dispersive device and a pump amplifier and wherein the pump source generates a chirped and amplified pump ultra-fast pulse;
a seed source, wherein the seed source is synchronized to the pump source and generates a chirped seed ultra-fast pulse;
a fiber parametric-chirp matched amplification (FPCMA) fiber, wherein the FPCMA fiber receives the chirped and amplified pump ultra-fast pulse and the chirped seed ultra-fast pulse, and wherein the chirped and amplified pump ultra-fast pulse and the chirped seed ultra-fast pulse have been path-matched and chirp-matched, wherein the chirp-match is at a fixed ratio of the chirped and amplified pump ultra-fast pulse to the chirped seed ultra-fast pulse as prescribed by an alignment point on a slope of a fiber dispersion curve for the fiber being used in the system; and
an output, wherein the output receives a chirp-matched amplified ultra-fast pulse from the FPCMA fiber, wherein the chirp-matched amplified ultra-fast pulse is dechirped to become an output signal centered at the targeted frequency and having a higher energy than the chirped seed ultra-fast pulse.

2. The system of claim 1, wherein the pump dispersive device is selected from the group consisting of fiber, a dispersive grating pair, and chirped fiber-bragg gratings.

3. The system of claim 1, wherein the seed source is (1) connected to the pump source and receives a fraction of a chirped pump ultra-fast pulse from the pump source, or (2) an independent light source that is synchronized electrically to the pump source,
wherein the seed source comprises a seed frequency shifter.

4. The system of claim 3, wherein the seed frequency shifter is selected from the group consisting of soliton self-frequency shift (SSFS) fibers, filtered superconinuum fibers, cascaded Raman fibers, and soliton self-mode conversion fibers.

5. The system of claim 3, wherein the seed source is an independent light source selected from the group consisting of mode-locked lasers, kerr resonators, and electrically generated sources.

6. The system of claim 3, wherein the seed source further comprises a seed dispersive device for chirp matching.

7. The system of claim 6, wherein the seed dispersive device is selected from the group consisting of fibers, a dispersive grating pair, and chirped fiber-bragg gratings.

8. The system of claim 1, further comprising an oscillator, wherein the oscillator generates ultra-fast pulses of light centered at a targeted frequency and wherein the pump source is connected to the oscillator and receives the ultra-fast pulses at the target frequency from the oscillator.

9. The system of claim 8, wherein the oscillator is used for both the pump source and the seed source, and wherein the chirped and amplified pump ultra-fast pulse and the chirped seed ultra-fast pulse are passively synchronized by matching their optical path length.

10. The system of claim 1, further comprising a delay line,
wherein the delay line is connected to the pump source and receives the chirped and amplified pump ultra-fast pulse from the pump source or wherein the delay line is connected to the seed source and receives the chirped seed ultra-fast pulse from the seed source, and
wherein the FPCMA fiber receives the chirped and amplified pump ultra-fast pulse from the pump source and the chirped seed ultra-fast pulse from the seed source.

11. The system of claim 1, wherein the pulse source further comprises a pulse picker.

12. The system of claim 11, the pulse picker is an acousto-optic modulator (AOM), wherein the AOM receives the chirped pump ultra-fast pulse from the pump dispersive device and wherein the pulse picker reduces the repetition rate of the chirped pump ultra-fast pulse.

13. The system claim 1, wherein the pump amplifier comprises a preamplifier and a large mode area fiber amplifier.

14. The system of claim 1, further comprising a frequency selective filter, wherein the filter selects for the amplified seed signal.

15. The system of claim 1, wherein (1) the chirped pump ultra-fast pulse from the pump source is an up-chirped pump ultra-fast pulse and wherein the chirped seed ultra-fast pulse from the seed source is a down-chirped seed ultra-fast pulse, or (2) the chirped pump ultra-fast pulse from the pump source is a down-chirped pump ultra-fast pulse and wherein the chirped seed ultra-fast pulse from the seed source is an up-chirped seed ultra-fast pulse, or (3) the chirped pump ultra-fast pulse from the pump source is an up-chirped pump ultra-fast pulse and wherein the chirped seed ultra-fast pulse from the seed source is an up-chirped seed ultra-fast pulse, or (4) the chirped pump ultra-fast pulse from the pump source is a down-chirped pump ultra-fast pulse and wherein the chirped seed ultra-fast pulse from the seed source is a down-chirped seed ultra-fast pulse.

16. The system of claim 1, wherein the chirp-matched amplified ultra-fast pulse is dechirped with a dispersive device.

17. A method for fiber optic parametric-chirped pulse amplification (FOP-CPA) comprising:
generating ultra-fast pulses of light centered at a targeted frequency from a pump source;
generating a chirped pump signal, wherein the chirped pump signal is generated from the ultra-fast pulses;
generating a chirped seed signal, wherein the chirped seed signal is generated from a fraction of the ultra-fast pulses that generated the chirped pump signal or from an independent seed source that is synchronized electrically to the pump source;
transferring the pump signal and the seed signal with a delay line to a fiber parametric-chirp matched amplification (FPCMA) fiber, wherein the pump signal and seed signal are path-matched;
chirp-matching the pump signal with the seed signal to amplify the seed signal through the FPCMA fiber, wherein a chirp-matched amplified ultra-fast pulse is an output signal from the FPCMA fiber; and
dechirping the output signal, wherein the dechirped output signal centered at the targeted frequency and having a higher energy than the seed signal.

18. The method of claim 17, wherein the center wavelength of the chirped pump signal is matched with the phase matched frequency of the chirped seed signal.

19. The method of claim 17, wherein the chirp-matching is at a fixed ratio of the chirped pump signal to the chirped seed signal as prescribed by an alignment point on a slope of a fiber dispersion curve for the FPCMA fiber.
